(19) United States
(12) Patent Application Publication
(10) Pub. No.: US 2009/0299757 A1
(43) Pub. Date: Dec. 3, 2009

(54) METHOD AND APPARATUS FOR ENCODING AND DECODING

(75) Inventors: Wei Guo, Shenzhen (CN); Peilin Liu, Shenzhen (CN); Wei Li, Shenzhen (CN); Lijing Xu, Shenzhen (CN); Qing Zhang, Shenzhen (CN); Jainfeng Xu, Shenzhen (CN); Shenghu Sang, Shenzhen (CN); Zhengzhong Du, Shenzhen (CN); Chen Hu, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzen (CN)

(21) Appl. No.: 12/508,103

(22) Filed: Jul. 23, 2009

Related U.S. Application Data
(63) Continuation of application No. PCT/CN2008/070170, filed on Jan. 23, 2008.

(30) Foreign Application Priority Data
Jan. 23, 2007 (CN) 200710006004.0

(51) Int. Cl. G10L 19/00

(52) U.S. Cl. 704/500; 704/E19.001

(57) ABSTRACT

An method for encoding comprising: obtaining, according to a data length of a first overlapped portion between encoding data of a current frame and encoding data of a previous frame, first encoding data corresponding to the data length of the first overlapped portion from the previous frame, if the previous frame is encoded in a first encoding mode and the current frame is to be encoded in a second encoding mode; and encoding, in the second encoding mode, the first encoding data corresponding to the data length of the first overlapped portion from the previous frame and encoding data of the current frame. The corresponding decoding method, encoding and decoding apparatuses are also disclosed.

### CROSS-REFERENCE TO RELATED APPLICATIONS

The present application is a continuation of International Patent Application No. PCT/CN2008/070170, filed on Jan. 23, 2008, which claims the benefit of Chinese Patent Application No. 200710006004.0, filed on Jan. 23, 2007, both of which are hereby incorporated by reference in their entireties.

### FIELD OF THE DISCLOSURE

The present disclosure relates to encoding and decoding technologies, and more particularly, to a method and apparatus for encoding and decoding.

### BACKGROUND

As the increasingly extensive deployment of multimedia services, there is a need for a higher encoding efficiency and real-time property in the encoding for the multimedia services due to the self-characteristics of the multimedia services. Meanwhile, the corresponding encoding bandwidth for audios needs to be further expanded.

Presently, the audio encoding techniques employed in this industry with a low bit rate and a high quality include the Adaptive Multi-Rate Wideband codec (AMR-WB+) technique. The based AMR-WB+ encoder mainly include two encoding modes as follow:
(1) Algebraic Code Excited Linear Prediction (ACELP) mode, for encoding voice; and
(2) Transform Coded excitation (TCX) mode, for encoding musical sound.

The AMR-WB+ technique is formed by expanding the voice encoding with a low bit rate, and is particularly a hybrid encoding manner formed by combining the ACELP encoding for voice and the TCX encoding for musical sound together. During the encoding for each frame, the encoding mode to be selected currently is determined by comparing the segmented signal to noise ratio (SEGSNR) values of the two modes. A mode switching situation is that: the ACELP encoding mode is employed for a previous frame, while the TCX encoding mode is required for a current frame. In this case, a corresponding policy may be employed during the encoding to eliminate the inter-frame discontinuity. Since the zero input response obtained from the previous frame state is significantly similar to the signal at the beginning of the current frame, in order to keep good smoothness at a mode transition, the AMR-WB+ utilizes an implementation scheme for removing the zero input response during the transition from an ACELP encoding frame to a TCX encoding frame.

For a mode switching situation where the ACELP encoding mode is employed for the previous frame and the TCX encoding mode will be employed for the current frame, the corresponding implementation process for the TCX encoding is as shown in FIG. 1. During the encoding, the input audio signal first passes through a perceptual weighting filter and is then determined. Then, the windowed zero input response (ZIR) is subtracted from the perceptual weighted signal, the resultant signal is further adaptively windowed and is encoded by the transform domain encoding to obtain the corresponding code stream encoded in the TCX mode.

In correspondence with FIG. 1, in the same mode switching situation, the corresponding implementation process for the TCX decoding is as shown in FIG. 2. After the input code stream encoded in the TCX mode is decoded, windowed and overlapped by the transform domain decoding, the transform domain decoded data will be added with the windowed ZIR since the ACELP encoding mode is employed for the previous frame, and reproduce the audio signal by the inverse perceptual weighting, thereby accomplishing the corresponding TCX decoding.

During implementing the present disclosure, the inventors found that in the TCX encoding and decoding processes involved in the AMR-WB+, the theoretical basis for the employed encoding and decoding schemes for eliminating the inter-frame discontinuity is the similarity between the zero input response and the signal at the beginning of the current frame. However, when the zero input response is not similar to the signal at the beginning of the current frame, the corresponding effect of eliminating the inter-frame discontinuity cannot be guaranteed. Moreover, it is required to calculate the zero input response of the synthesis weighting filter during the process of eliminating the inter-frame discontinuity, and the corresponding algorithm is relatively complex, so that the implementing of the encoding and decoding is more complex accordingly.

### SUMMARY

Embodiments of the present disclosure provide a method and apparatus for encoding and decoding, in order to make the process for eliminating the inter-frame discontinuity during the encoding and decoding less complex, thereby enabling the implementing of the encoding and decoding less complex.

An encoding method is provided in an embodiment of the present disclosure, comprising:

obtaining, according to a data length of an overlapped portion between encoding data of a current frame and encoding data of a previous frame, encoding data corresponding to the data length of the overlapped portion from the previous frame if the previous frame is encoded in a first encoding mode and the current frame is to be encoded in a second encoding mode; and

encoding, in the second encoding mode, the obtained encoding data of the data length of the overlapped portion from the previous frame and encoding data of the current frame to obtain an encoding result.

An encoding apparatus is provided in an embodiment of the present disclosure, comprising: an encoding mode switching recognition unit, a previous encoding frame overlapped data obtaining unit, and a second encoding unit, wherein:

the encoding mode switching recognition unit is configured to determine that a previous frame is encoded in a first encoding mode and a current frame is to be encoded in a second encoding mode, so as to trigger the previous encoding frame overlapped data obtaining unit to work;

the previous encoding frame overlapped data obtaining unit is configured to obtain, according to a data length of an overlapped portion between encoding data of the current frame and encoding data of the previous frame, encoding data corresponding to the data length of the overlapped portion from the previous frame; and the second encoding unit is configured to encode, in the second encoding mode, the encoding data obtained by the previous encoding frame overlapped data obtaining unit and encoding data of the current frame to obtain an encoding result.

A decoding method is provided in an embodiment of the present disclosure, comprising:

decoding a received code stream, and determining that a previous frame is decoded in a first decoding mode and a current frame is decoded in a second decoding mode;

obtaining, according to a determined data length of an overlapped portion between decoding data of the current frame and decoding data of the previous frame, decoding data corresponding to the data length of the overlapped portion from the previous frame; and

overlapping the decoding data obtained from the previous frame and decoding data of the current frame to obtain a decoding result.

A decoding apparatus is provided in an embodiment of the present disclosure, comprising a decoding mode switching recognition unit, a previous decoding frame overlapped data obtaining unit and a second decoding unit, wherein:

the decoding mode switching recognition unit is configured to determine that a previous frame is decoded in a first decoding mode and a current frame is decoded in a second decoding mode according to information in a decoded code stream, so as to trigger the previous decoding frame overlapped data obtaining unit to work;

the previous decoding frame overlapped data obtaining unit is configured to obtain, according to data length of an overlapped portion between decoding data of the current frame and decoding data of the previous frame, decoding data corresponding to the data length of the overlapped portion from the previous frame, and provide the decoding data to the second decoding unit; and

the second decoding unit is configured to overlap the decoding data obtained by the previous decoding frame overlapped data obtaining unit and decoding data of the current frame to obtain a decoding result.

As can be seen from the technical schemes according to the embodiments of the disclosure above, the embodiments of the disclosure may achieve mode switching during the corresponding encoding and decoding processes without the filter computation, so as to enable the computation of the entire encoding and decoding processes to be relatively simple, and facilitate the implementation by software and hardware. Meanwhile, the effect of eliminating the inter-frame discontinuity if the zero input response is not similar to the signal at the beginning of the current frame may be effectively guaranteed according to the embodiments of the disclosure.

### BRIEF DESCRIPTION OF THE DRAWINGS

FIG. 1 is a schematic block diagram of a TCX encoding process in the prior art;

FIG. 2 is a schematic block diagram of a TCX decoding process in the prior art;

FIG. 3 is a schematic diagram of the time domain window function w(n) applied in the process of calculating the windowed ZIR value in the prior art;

FIG. 4 is a schematic block diagram of a TCX encoding process according to an embodiment of the present disclosure;

FIG. 5 is a schematic block diagram of a TCX decoding process according to an embodiment of the present disclosure;

FIG. 6 is a schematic diagram of the structure of an input voice frame according to an embodiment of the present disclosure;

FIG. 7 is a schematic diagram of a windowed shape according to an embodiment of the present disclosure;

FIG. 8 is a schematic diagram of inter-frame overlap smoothing in a decoding process according to an embodiment of the present disclosure; and

FIG. 9 is a schematic diagram of apparatuses for encoding and decoding according to an embodiment of the present disclosure.

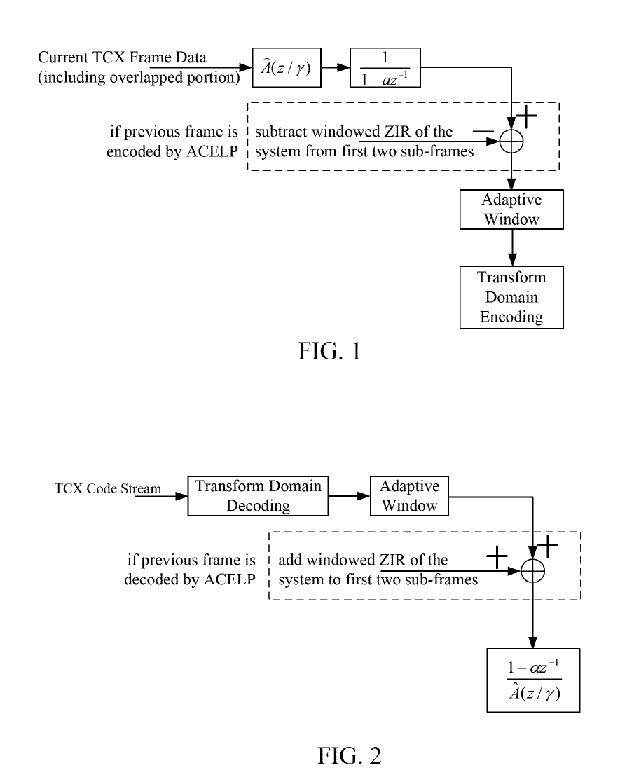

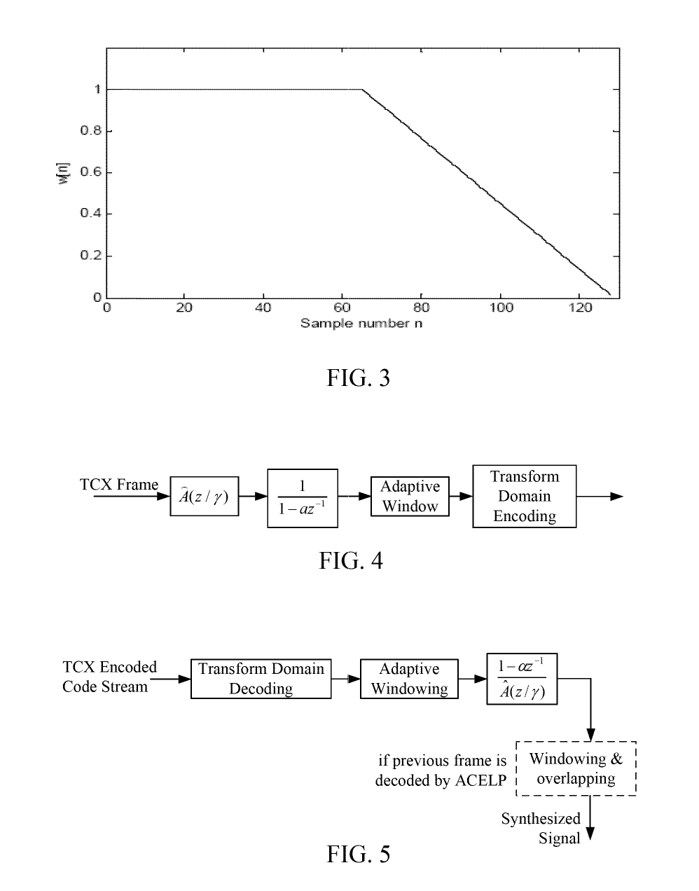

### DETAILED DESCRIPTION

An embodiment of encoding of the present disclosure includes: obtaining encoding data of a data length of an overlapped portion from a previous frame and encoding data of a data length of an overlapped portion from a next frame according to the corresponding data length of the overlapped portion between encoding data of the current frame and encoding data of the previous frame as well as between encoding data of the current frame and encoding data of the next frame respectively, upon determining that the previous frame is encoded in a first encoding mode and further determining that the current frame is to be encoded in a second encoding mode, i.e., determining that the encoding mode switching occurs during the encoding; and encoding the encoding data obtained from the data of the previous frame and the next frame along with the encoding data of the current frame based on the second encoding mode to obtain an encoding result. The data lengths of the overlapped portions are determined from the frame lengths of the encoding frames and are preset in the encoder. The longer the frame length of an encoding frame is, the longer the data length of the corresponding overlapped portion will be.

It should be pointed out that, in this embodiment, it is assumed that the data length of the overlapped portion between encoding data of the current frame and encoding data of the previous frame is a first length, and the data length of the overlapped portion between encoding data of the current frame and encoding data of the next frame is a second length. Then preferably, the first length may be identical to the second length; however, the two length values are not necessarily the same in the specific applications of the embodiments of the present disclosure.

In an embodiment of the present disclosure, specifically the first encoding mode may be, but not limited to, the linear prediction encoding mode, and the second encoding mode may be, but not limited to, the transform domain encoding. Further, the corresponding embodiments may be applied in the encoding having mode switching between the various linear prediction encoding and transform domain encoding modes, e.g., the mode switching from the ACELP encoding to the TCX encoding, and so on.

Accordingly, an embodiment of decoding in the present disclosure includes: decoding a received code stream and upon it is determined that a previous frame in the received code stream is decoded in a first decoding mode and a current frame is decoded in a second decoding mode, obtaining. according to a determined data length of an overlapped portion between decoding data of the previous frame and decoding data of the current frame, decoding data corresponding to the data length of the overlapped portion from the previous frame; and overlapping the decoding data obtained from the previous frame with the decoding data of the current frame, specifically the decoding data of the data length of the overlapped portion from the previous frame and the header of the decoding data of the current frame is windowed and overlapped to obtain the decoding result.

The AMR-WB+ encoding is taken as an example in illustration. with respect to the transition from an ACELP encoding (i.e., linear prediction encoding) frame to a TCX encoding (i.e., the transform domain encoding) frame, an embodiment of the present disclosure proposes an overlap smoothing technique for switching between the ACELP and the TCX encoding modes, which is able to obtain a better inter-frame smoothing effect while the bit rate is guaranteed to be unchanged. And in the process of applying the embodiment, the complex calculation of a synthesis perceptual weighting filter is not required, so that the corresponding calculation complexity is reduced compared with the inter-mode smoothing techniques for the AMR-WB+ in the prior art.

In other words, an embodiment of the present disclosure mainly employs an inter-mode overlap smoothing technique to reduce the effect on the encoding caused by the switching between two encoding modes. This embodiment intends to improve the TCX encoding and decoding efficiency, and reduce the TCX encoding and decoding complexity by the TCX encoding and decoding process. The TCX encoding and decoding technique schemes based on the inter-mode overlap smoothing technique of the present disclosure is illustrated below.

(I) TCX Encoding Scheme Employing Inter-Mode Overlap Smoothing Technique

The specific implementation of this scheme is as shown in FIG. 4. An input TCX frame signal for TCX encoding is processed by a perceptual weighting filter, adaptively windowed, and encoded by the transform domain encoding to obtain a code stream encoded in the TCX mode. If a previous frame is encoded in the ACELP mode, then a data length of the currently input TCX frame signal to be overlapped with a next frame is halved. Meanwhile, the reserved space is complemented with values of several sample points in the last sub-frame of the previous frame. That is, the encoding data of the current frame, the encoding data of the overlapped portion of both the previous frame and the current frame, and the encoding data of the overlapped portion of both the next frame and the current frame are encoded, so as to achieve inter-frame smoothing.

It is apparent that, in the embodiment shown in FIG. 4, the removal for the zero input response is no longer required, so that the process of the encoding may be simplified. Meanwhile, the effective inter-frame smoothing may be achieved since smoothing is performed between the current frame and the previous frame as well as between the current frame and the next frame with the overlapped data, respectively.

(II) TCX Decoding Scheme Employing Inter-Mode Overlap Smoothing Technique

In correspondence with the TCX encoding scheme above, the block diagram of the implementation of the corresponding TCX decoding scheme is as shown in FIG. 5. In the decoding process, a TCX decoder receives a code stream encoded in the TCX mode sent from a TCX encoder, performs transform domain decoding, windowing and overlapping within TCX mode on the received code stream, and passes it through an inverse perceptual weighting filter to obtain a synthesized audio signal. If the ACELP encoding mode is employed for the previous frame, then a processing policy is employed at the decoder in correspondence with the encoder above to perform overlapping with the portion in the decoded result of the previous frame that is overlapped with the current frame, so as to obtain the decoding result of the current frame. Referring to the instance in the encoding process above, the starting overlapped portion of the current frame and the last sub-frame of the ACELP synthesized signal for the previous frame are windowed and overlapped in the TCX decoder, resulting in the final synthesized audio signal.

For purpose of understanding the embodiments of the present disclosure, the encoding and decoding algorithms in accordance with the embodiments of the present disclosure will be described in details by reference to the accompanying drawings, i.e., the encoding and decoding processes where the ACELP encoding mode is employed for the previous frame and the TCX encoding mode is employed for the current frame will be illustrated.

(I) Encoding Process

Still referring to FIG. 4, for the situation where a previous frame is encoded in the ACELP mode and a current frame is to be encoded with the TCX, the available inter-frame overlapping techniques include:

TCX encoding the audio data of the current frame along with the last several pieces of ACELP processed audio data (e.g., 16, 32 or 64 points speech data) in the previous frame according to the TCX encoding mode (e.g., a TCX encoding mode with an encoding frame length of 256, 512 or 1024) for the current frame, the last several pieces of audio data referring to the audio data of a data length of the portion overlapped with the previous frame that is determined according to the encoding frame length.

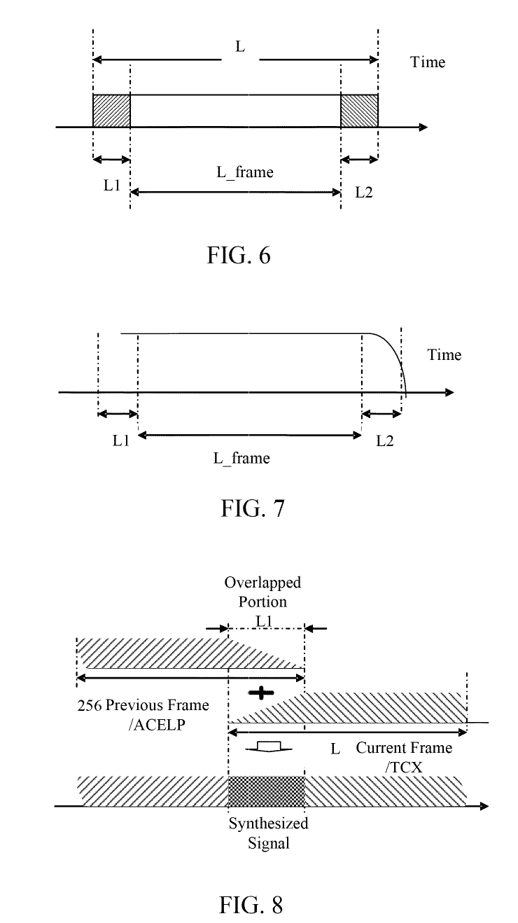

The structure of the input audio frame for the corresponding TCX encoder is as shown in FIG. 6, wherein the L_frame represents the TCX encoding frame length of the current frame, which may be 256, 512 or 1024, corresponding to the three encoding modes of TCX, respectively; wherein L1 represents the length of the audio signal overlapped with the previous frame, L2 is the sample number of the audio signal overlapped with the next frame, and L represents the actually processed audio signal length of the current frame. The values for the parameters in FIG. 6 may be:

if L_frame=256, L1=16, L2=16, L=288;

if L_frame=512, L1=32, L2=32, L=576;

if L_frame=1024, L1=64, L2=64, L=1152.

Therefore, the length overlapped between the current frame and the previous frame varies with the changing of the TCX encoding modes and has an adaptive effect. Meanwhile, the actual frame length of each frame of a speech signal that is TCX processed in this method is matched with the actual frame length in the AMR-WB+, thereby ensuring the preciseness of encoding.

The speech signal to be encoded in TCX mode is processed by the perceptual weighting filter, and then is adaptively windowed by a window as shown in FIG. 7, wherein:

w(n)=sin(2πn/(4L2)), for n=L2, . . . , (2L2−1);

wherein w(n) refers to the curve shown in the section of L2 in FIG. 7; in other words, the portion overlapped with the previous frame is not windowed, while the portion overlapped with the next frame is windowed by a cosine window w(n).

Moreover, since a portion overlapped with the previous frame is set, the window length of the cosine window is only half of the window length of the cosine window in the AMR-WB+.

In addition, if the next frame is still encoded in TCX mode, the window length for windowing the frame header of the next frame should be consistent with the length of L2, that is, the corresponding overlapped portion should have a length consistent with the current frame, in order to ensure the effect of inter-frame smoothing.

(II) Decoding Process

In correspondence with the encoding process above, the TCX decoder decodes the synthesized audio signal of the current frame from the received code stream, encoded in the TCX mode, of the current frame, windows and overlaps the head overlapped portion with the ACELP decoded audio signal of the previous frame to generate the final synthesized audio output.

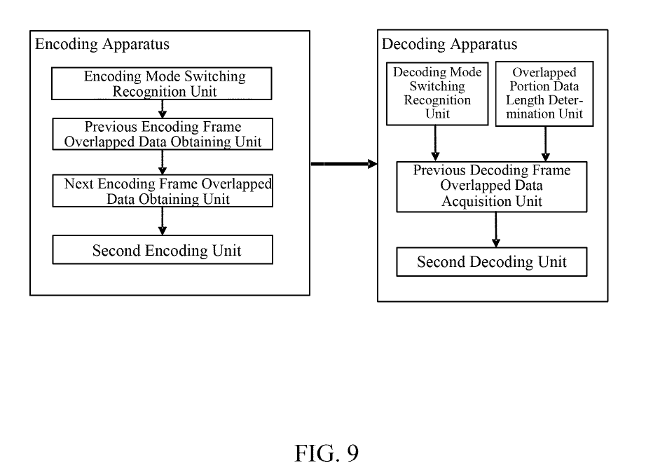

In particular, the synthesized audio signal decoded from the previous ACELP encoding frame and the audio signal decoded from the current TCX encoding frame are windowed as shown in FIG. 8, and then the final synthesized audio signal is obtained by overlapping the overlapped portions.

Referring to FIG. 8, a triangular window is employed for the overlapped portion, the synthesized audio signal of the last L1 sample points of the ACELP is represented as w₂(n), and the synthesized audio signal of the overlapped portion of the TCX is represented as w₁(n), then the corresponding synthesized audio signal is as follow:

w₁(n)=n/L1, for n=0, . . . , L₁;

w₂(n)=(L1−n)/L1, for n=0, . . . , L₁.

With the process above, the corresponding TCX decoding may be completed successfully to obtain the corresponding TCX decoding result.

An embodiment of encoding and decoding apparatuses is also provided in an embodiment of the present disclosure as shown in FIG. 9, including an encoding apparatus and a decoding apparatus. The specific implementation structures of the two apparatuses will be described below.

(I) Encoding Apparatus

The apparatus includes an encoding mode switching recognition unit, a previous encoding frame overlapped data obtaining unit, a next encoding frame overlapped data obtaining unit and a second encoding unit, wherein:

the encoding mode switching recognition unit is configured to determine that a previous frame is encoded in a first encoding mode and a current frame is to be encoded in a second encoding mode, so as to trigger the previous encoding frame overlapped data obtaining unit and the next encoding frame overlapped data obtaining unit to work;

the previous encoding frame overlapped data obtaining unit is configured to obtain, according to a determined data length of an overlapped portion between encoding data of the current frame and encoding data of the previous frame, encoding data corresponding to the data length of the overlapped portion from the previous frame, for example, obtaining the encoding data corresponding to the data length of the overlapped portion from the previous frame, and provide the encoding data to the transform domain encoding unit (i.e., the second encoding unit);

the next encoding frame overlapped data obtaining unit is configured to obtain, according to a determined data length of an overlapped portion between encoding data of the current frame and encoding data of a next frame, encoding data corresponding to the data length of the overlapped portion from the next frame, and provide the encoding data to the transform domain encoding unit (i.e., the second encoding unit); wherein taking the TCX encoding mode being the second encoding mode as an example, since a corresponding smoothing scheme is required in the present encoding between TCX frames, such a unit may be still employed in this embodiment of the apparatus to perform the corresponding inter-frame smoothing; and

the second encoding unit is configured to overlap the encoding data obtained by the previous encoding frame overlapped data obtaining unit and the next encoding frame overlapped data obtaining unit with the encoding data of the current frame to obtain the encoding result, so as to achieve inter-frame smoothing.

In this apparatus, the data length of the overlapped portion employed in the previous frame overlapped data obtaining unit and the data length of the overlapped portion employed in the next frame overlapped data obtaining unit are predetermined according to the frame length of the encoding frame respectively. In particular, it is assumed that the data length of the overlapped portion employed in the previous frame overlapped data obtaining unit is the first length and the data length of the overlapped portion employed in the next frame overlapped data obtaining unit is the second length, then the first length is, but not limited to be necessarily, equal to the second length.

(II) Decoding Apparatus

This apparatus includes a decoding mode switching recognition unit, a previous decoding frame overlapped data obtaining unit and a second decoding unit, wherein:

the decoding mode switching recognition unit is configured to determine, during the second decoding unit decodes the received code stream, that a previous frame in the received code stream is decoded in a first decoding mode and that a current frame is decoded in a second decoding mode, so as to trigger the previous decoding frame overlapped data obtaining unit to work, and in particular, the decoding mode switching recognition unit is configured to determine that the previous frame is decoded in the first decoding mode and the current frame is decoded in a second decoding mode according to information in decoded code stream;

the previous decoding frame overlapped data obtaining unit is configured to obtain, according to a determined data length of an overlapped portion between decoding data of the current frame and decoding data of the previous frame, decoding data corresponding to the data length of the overlapped portion from the previous frame, and provide the decoding data to the second decoding unit;

the second decoding unit is configured to decode the received code stream, and window and overlap the decoding data obtained by the previous decoding frame overlapped data obtaining unit with the decoding data of the current frame to obtain a decoding result; and

the overlapped portion data length determination unit is configured to determine a data length of an overlapped portion according to indication information in the received code stream, and provide the data length to the previous decoding frame overlapped data obtaining unit, for example, transferring the encoding mode (i.e., the frame length of the encoding frame) in a code stream to the decoder, which will determine the corresponding data length value of the overlapped portion according to the encoding mode upon receiving the encoding mode. However, the data length value of the overlapped portion that may be employed by the decoder may be indicated with other indication information.

In the apparatus above, the first encoding mode is a linear prediction encoding mode, and the second encoding mode is transform domain encoding.

It should be pointed out that, the embodiments of the present disclosure are applicable to the issues caused by switching between two different encoding modes or between two different decoding modes. In particular, the first and second encoding modes may be overlapped and encoded to smooth the encoding and decoding quality loss due to switching, thereby improving the encoding and decoding quality. For example, the embodiments may be applied to the smoothing for a transition from the ACELP encoding mode to the advanced audio encoding (AAC) mode, or applied to the smoothing for a transition from the linear prediction excited encoding (CELP) mode to the AAC mode, or applied to the smoothing for a transition from the ACELP encoding mode to the Modified Discrete Cosine Transform (MDCT) encoding mode, and so on.

As described above, a good inter-frame smoothing effect may be achieved since the overlap computation is carried out on the synthesized audio signal at the decoder. Moreover, the filter computation is not required in the embodiments of the present disclosure, thereby keeping the computation complexity of the entire encoding and decoding processes low, and facilitating the implementation by software and hardware.

The foregoing are merely exemplary embodiments of the present disclosure, and thus the scope of the present disclosure is not limited to such embodiment. Any variations and equivalents that may be readily conceived by those skilled in the art within the technical scope disclosed by the present disclosure are intended to be covered by the scope of the present disclosure. Therefore, the scope of the present disclosure should be construed by the scope defined in the claims.

1-16. (canceled)

17. An encoding method, comprising:
obtaining, according to a data length of a first overlapped portion between encoding data of a current frame and encoding data of a previous frame, first encoding data corresponding to the data length of the first overlapped portion from the previous frame, if the previous frame is encoded in a first encoding mode and the current frame is to be encoded in a second encoding mode; and
encoding, in the second encoding mode, the first encoding data corresponding to the data length of the first overlapped portion from the previous frame and encoding data of the current frame.

18. The method of claim 17, characterized in that, the first encoding mode is a linear prediction encoding mode, and the second encoding mode is transform domain encoding.

19. The method of claim 17, characterized in that, the method further comprises:
presetting the data length of the overlapped portion between encoding data of neighbor frames; or
determining, according to a frame length of the current frame, the data length of the first overlapped portion between the encoding data of the current frame and the encoding data of the previous frame; or
determining, according to the frame length of the current frame, the data length of the second overlapped portion between the encoding data of the current frame and the encoding data of the next frame.

20. The method of claim 17, characterized in further comprising:
obtaining, according to a data length of a second overlapped portion between the encoding data of the current frame and encoding data of a next frame, second encoding data corresponding to the data length of the second overlapped portion from the next frame;
the process of encoding in the second encoding mode the first encoding data corresponding to the data length of the first overlapped portion from the previous frame and encoding data of the current frame comprises:
encoding, in the second encoding mode, the first encoding data corresponding to the data length of the first overlapped portion from the previous frame, the encoding data of the current frame and the second encoding data corresponding to the data length of the second overlapped portion from the next frame

21. The method of claim 18, characterized in further comprising:
obtaining, according to a data length of a second overlapped portion between encoding data of the current frame and encoding data of a next frame, second encoding data corresponding to the data length of the second overlapped portion from the next frame; and
the process of encoding in the second encoding mode the first encoding data corresponding to the data length of the first overlapped portion from the previous frame and encoding data of the current frame comprises
performing transform domain encoding on the first encoding data corresponding to the data length of the first overlapped portion from the previous frame, the encoding data of the current frame and the second encoding data corresponding to the data length of the second overlapped portion from the next frame.

22. The method of claim 19, characterized in that, the data length of the first overlapped portion between encoding data of the current frame and encoding data of the previous frame is identical with the data length of the second overlapped portion between encoding data of the current frame and encoding data of the next frame.

23. An encoding apparatus, comprising an encoding mode switching recognition unit, a previous encoding frame overlapped data obtaining unit, and a second encoding unit, wherein:
the encoding mode switching recognition unit is configured to determine that a previous frame is encoded in a first encoding mode and a current frame is to be encoded in a second encoding mode;
the previous encoding frame overlapped data obtaining unit is configured to obtain, according to a data length of a first overlapped portion between encoding data of the current frame and encoding data of the previous frame, first encoding data corresponding to the data length of the first overlapped portion from the previous frame, if the encoding mode switching recognition unit determines that the previous frame is encoded in the first encoding mode and the current frame is to be encoded in the second encoding mode; and
the second encoding unit is configured to encode, in the second encoding mode, the first encoding data obtained by the previous encoding frame overlapped data obtaining unit and encoding data of the current frame.

24. The apparatus of claim 23, characterized in further comprising:
a next encoding frame overlapped data obtaining unit, configured to obtain, according to a data length of a second overlapped portion between the encoding data of the current frame and encoding data of a next frame, second encoding data corresponding to the data length of the second overlapped portion from the next frame;
the second encoding unit is further configured to encode, in the second encoding mode, the first encoding data obtained by the previous encoding frame overlapped data obtaining unit, the encoding data of the current frame and the second encoding data obtained by the next encoding frame overlapped data obtaining unit.

25. The apparatus of claim 23, characterized in that, the first encoding mode is a linear prediction encoding mode, and the second encoding mode is transform domain encoding, in which the apparatus further comprising
a next encoding frame overlapped data obtaining unit, configured to obtain, according to a data length of a second overlapped portion between the encoding data of the current frame and encoding data of a next frame, second encoding data corresponding to the data length of the second overlapped portion from the next frame;
the second encoding unit is a transform domain encoding unit being configured to perform transform domain encoding on the first encoding data obtained by the previous encoding frame overlapped data obtaining unit, the encoding data of the current frame and the second encoding data obtained by the next encoding frame overlapped data obtaining unit.

26. A decoding method, comprising:
decoding a received code stream, and when it is determined that a previous frame is decoded in a first decoding mode and a current frame is decoded in a second decoding mode, obtaining, according to a data length of a third overlapped portion between decoding data of the current frame and decoding data of the previous frame, third decoding data corresponding to the data length of the third overlapped portion from the decoding data of the previous frame; and overlapping the third decoding data and the decoding data of the current frame.

27. The method of claim 26, characterized in that, a first encoding mode is a linear prediction encoding mode, and a second encoding mode is transform domain encoding.

28. The method of claim 26, characterized in further comprising:
determining, according to indication information in the received code stream, a data length of an overlapped portion between decoding data of neighbor frames.

29. The method of claim 26, characterized in that the process of overlapping the third decoding data and the decoding data of the current frame comprises:
windowing and overlapping headers of the third decoding data and the decoding data of the current frame.

30. A decoding apparatus, comprising: a decoding mode switching recognition unit, a previous decoding frame overlapped data obtaining unit and a second decoding unit, wherein:
the decoding mode switching recognition unit is configured to determine that a previous frame in a received code stream is decoded in a first decoding mode and a current frame in the received code stream is decoded in a second decoding mode;
the previous decoding frame overlapped data obtaining unit is configured to obtain, according to a data length of a third overlapped portion between decoding data of the current frame and decoding data of the previous frame, third decoding data corresponding to the data length of the third overlapped portion from the decoding data of the previous frame, if the decoding mode switching recognition unit determines that the previous frame is decoded in the first decoding mode and the current frame is decoded in the second decoding mode; and
the second decoding unit is configured to decode the received code stream, and to overlap the third decoding data obtained by the previous decoding frame overlapped data obtaining unit and decoding data of the current frame.

31. The apparatus of claim 30, characterized in that, the first encoding mode is a linear prediction encoding mode, and the second encoding mode is transform domain encoding:
the second decoding unit is further configured to perform transform domain encoding on the received current frame code stream, and to window and overlap the third decoding data obtained by the previous decoding frame overlapped data obtaining unit and the decoding data of the current frame.

32. The apparatus of claim 30, characterized in further comprising an overlapped portion data length determination unit, configured to determine a data length of an overlapped portion between decoding data of neighbor frames according to indication information in the received code stream.

33. The apparatus of claim 30, characterized in that the decoding mode switching recognition unit is further configured to determine that the previous frame is decoded in the first decoding mode and the current frame is decoded in the second decoding mode according to information in decoded code stream.

34. A system, comprising:
an encoding apparatus, configured to obtain, according to a data length of a first overlapped portion between encoding data of a current frame and encoding data of a previous frame, first encoding data corresponding to the data length of the first overlapped portion from the previous frame, if the previous frame is encoded in the first encoding mode and the current frame is to be encoded in the second encoding mode, and to encode, in the second encoding mode, the first encoding data corresponding to the data length of the first overlapped portion from the previous frame and encoding data of the current frame, to output encoded code stream;
a decoding apparatus, configured to decode a received code stream, and to obtain, according to a data length of a third overlapped portion between decoding data of a current frame and decoding data of a previous frame, third decoding data corresponding to the data length of the third overlapped portion from the decoding data of the previous frame, if the previous frame in the received code stream is decoded in the first decoding mode and the current frame in the received code stream is decoded in the second decoding mode; and to overlap the third decoding data and decoding data of the current frame.
